(19) United States
(12) Patent Application Publication
(10) Pub. No.: US 2012/0297335 A1
(43) Pub. Date: Nov. 22, 2012

(54) DOCUMENT GLANCING AND NAVIGATION

(75) Inventors: Kannan Ramasubramanian, Hyderabad (IN); Nithin Ismail, Hyderabad (IN); Premalini David, Hyderabad (IN); Gokul Singh, Hyderabad (IN); Biju Venugopal, Hyderabad (IN)

(73) Assignee: MICROSOFT CORPORATION, Redmond, WA (US)

(21) Appl. No.: 13/109,048

(22) Filed: May 17, 2011

(51) Int. Cl. G06F 3/048

(52) U.S. Cl. 715/787

(57) ABSTRACT

When viewing a document, a user may switch between detailed reading of the document, and glancing at the structure of the document, in a single smooth flow of actions. In one example, a document is shown with a navigation bar that has a thumb. Before the user clicks the thumb, the document is shown at its current position at a first zoom level. When the user clicks and holds the thumb, the current page of the document is shown at a second zoom level, which may be a full-page zoom level at which an entire page of the document fits in the viewing area. The user may drag the thumb, thereby changing the current page being shown at the second zoom level. When the use releases the thumb, the current page may be shown at the first zoom level.

### BACKGROUND

When a user is reading a document on a device equipped with an electronic screen, there are various options available for navigating and viewing the document. As to navigation, software on the device may present a scroll bar alongside the document. The scroll bar may have a track with a “thumb” in the track, and arrows at either end of the track. To move up and down the document, the user can either click up or down arrows, or can drag the thumb in the track, or can click on some point within the track.

As to viewing, the user may have various zoom options. The document may have a native resolution, and the user may be able to view the document at this native resolution (100% zoom), or may set the zoom level up or down. Some applications or software environments allow the user to set the zoom level based on certain physical parameters of the window. For example, there might be an option to set the zoom level such that the width of a page of the document fills the width of the window. Or, there might be an option to set the zoom level such that the document appears as large as it can, while still fitting inside of one window.

### SUMMARY

Navigation and viewing features may be combined in a way that allows a user to navigate through a document while glancing at specific parts of the document as part of a single flow of actions.

A document that is being shown to a user may have a navigation bar with a thumb. Before the user clicks on the thumb, the user may be viewing a specific part of the document at a first zoom level. When the user uses a pointing device to click and hold down the thumb, the zoom level may be set to a second zoom level. The second zoom level is such that the entire page fits in the viewing area. While the user holds down the thumb, a flyout from the navigation bar may be shown; the flyout may show, for example, a thumbnail of the page and/or the page number. While the user holds down the thumb, the user may move the thumb up or down to change the page that appears in the window. While the user holds and moves the thumb, whatever page appears in the window appears at the second zoom level. If a flyout appears, the flyout may change to show a thumbnail and/or the number of the appropriate page, while the user is moving the thumb. When the user releases the thumb (either after having moved it, or without having moved it), the page that is currently shown in the window switches to the first zoom level. Also, if a flyout is present, releasing the thumb may cause the flyout to disappear.

If the user clicks on a non-thumb part of the navigation bar, various actions may be taken. For example, if the bar is calibrated to the number of pages in the document (e.g., if the page corresponding to one-quarter of the way down the navigation bar is the page that is approximately one quarter of the way from the first page to the last page), then clicking on a non-thumb part of the navigation bar may cause the page corresponding to that position to be shown in the window at the second zoom level, and/or may cause a flyout for that page to be shown.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example view of an application, in which navigation and glancing may occur.

FIG. 2 is a block diagram of the example view of FIG. 1, with the thumb having been dragged to a different position along a track.

FIG. 3 is a block diagram of the example view of FIG. 1, with the user having released the thumb.

FIG. 4 is a flow diagram of an example process in which a user switches from detailed reading, to glancing, and then back to detailed reading mode.

FIG. 5 is a flow diagram of an example process that may occur if a user clicks the navigation bar at a location other than the thumb.

FIG. 6 is a block diagram of example components that may be used in connection with implementations of the subject matter described herein.

### DETAILED DESCRIPTION

Devices, and the software used on devices, provide mechanisms for reading a document. Two basic operations that a user can perform in order to view a document are navigation (moving to different positions in the document) and changing the zoom level. When users are reading documents, they may want to see the document in different ways to achieve different purposes. For example, when a user wants to read the document closely, the user may want to view the document at a high zoom level so that the words are easy to read. On the other hand, the user may want to look at large portions of the document at once in order to find a particular element in the document, such as a particular picture, chart, or section heading. This latter way of looking at the document may be referred to as “glancing”, and it is typically done at a low zoom level. Since the purpose of glancing is to find a part of the document quickly, rather than to examine the document in detail, the user may be willing to accept a loss of visual detail in order to see more of the document at once.

Users may want to switch quickly between detailed viewing and glancing. For example, a user might want to find a picture in a document, then read the section associated with that picture, then find another section of the document, then read that other section, etc. However, many user interfaces do not allow the user to switch easily between glancing and detailed reading, while also being able to move around the document, as part of a single flow of actions.

The subject matter herein allows a user to combine detailed reading with glancing in a seamless way. A document of any type (e.g., a word processing document, a drawing, a document in Portable Document Format (PDF), etc.) may be shown to a user in a window that has a navigation bar. The navigation bar has a track, and also has a thumb that can be moved within the track. The user can move up and down the document by using a pointing device (such as a mouse, track pad, touch screen, etc.) to click and hold the thumb, while dragging the thumb in the track. Prior to the user clicking the thumb, the document may be shown at a first zoom level. This zoom level may be the native zoom level associated with the document, or may be a zoom level that has been pre-selected by the user (or by some other entity). When the user clicks and holds the thumb, the document changes to a second zoom level. The second zoom level may be a “full-page” zoom level that is chosen so that an entire page of the document fits within the window. In one example, the “full-page” zoom level provides more detail than a thumbnail, which provides sufficient fidelity to allow the user to read the content, or otherwise to discern a page's detail, even when the document is being shown at the second zoom level. The user may then release the thumb, thereby causing the zoom level to return to the first zoom level. Or, the user may drag the thumb along the track, thereby moving from page to page in the document. As the user moves through the pages, each page may be shown in the window at the second zoom level, thereby allowing a full-page view. When the user releases the thumb, the page that is currently being shown in the window may switch to the first zoom level, which may be, for example, a zoom level that allows for comfortable detailed reading.

In addition to being able glance at pages at a full-page zoom level by clicking the thumb, the user may also be able to glance at pages by clicking elsewhere on the navigation bar's track. For example, if the navigation bar is calibrated to the number of pages in the document (e.g., if the page corresponding to one-quarter of the way down the navigation bar is the page that is approximately one quarter of the way from the first page to the last page), then clicking and holding the non-thumb part of the navigation bar's track at a particular position may cause the page corresponding to that position in the document (e.g., page 25 out of a 100 page document) to be shown in the window at the second zoom level, and a flyout may also be shown that represents that page. Releasing the click may resume viewing at the original zoom level, either at the place in the document where the user had been viewing before the click, or at the place in the document indicated by where, on the navigation bar, the user clicked.

It is noted that some systems may provide a way for users to switch to a full-page zoom level while navigating. E.g., a device may switch to a full-page zoom level when the user clicks the thumb, and may then allow the user to flip through pages the full-page zoom level. However, such devices may not switch back to the native or previous zoom level when the user releases the thumb, so the actions of the user do not constitute a seamless transition between glancing and detailed reading. Moreover, it is noted that a system that switches to full-page zoom when the user holds the thumb, and then switches back to the native or previous zoom level when the user releases the thumb, is not an obvious change from a system that switches to full-page zoom level when the user hold the thumb but that does not switch back to the previous zoom level when the user releases the thumb. In the former case, the user is able to switch back and forth between detailed reading and glancing with a simple set of motions that flow together. On the other hand, in the latter case, the change from one zoom level to another is durable, and does not constitute a way of changing back and forth between glancing and detailed reading.

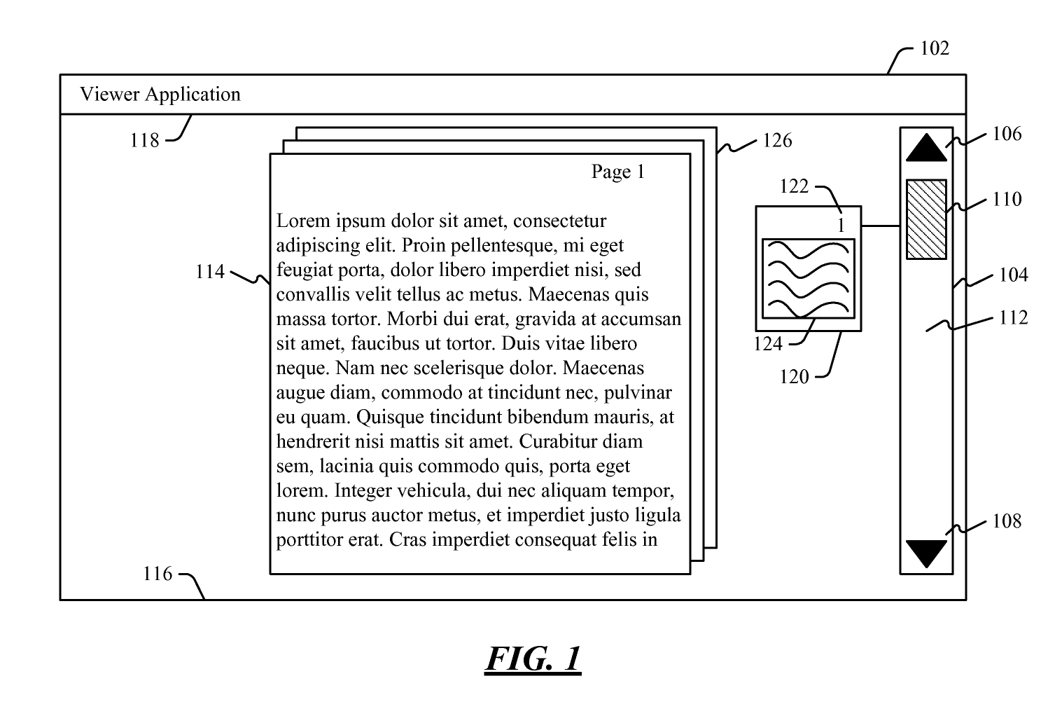

Turning now to the drawings, FIG. 1 shows an example view of an application, in which navigation and glancing may occur. In the example of FIG. 1, the view that is shown is window 102, as might be shown on a personal computer, although the view could take any form appropriate for the device or platform on which it is being shown. For example, a phone or music player might have an operating system that does not provide windows as part of the user interface, in which case the view of an application might be the entire screen of such a device. It will be understood that, while FIG. 1 uses window 102 as an example view, the features described in FIG. 1 apply to any appropriate type of application view (e.g., a full-screen view on certain models of phone that support only a single view at a given time).

In this example, the application shown in window 102 is a “Viewer Application,” which allows the user to see some type of document, such as a PDF document, a word processing document, etc. An example document 114 is shown within window 102. The example document 114 is shown as a text document containing the “Lorem ipsum . . . ” placeholder text, although document 114 could be any type of document—e.g., a spreadsheet, a slide deck, a set of images, etc.

Window 102 has a navigation bar 104, which may include various features such as up arrow 106 and down arrow 108 (which the user can click to move up and down the document), thumb 110, and track 112 in which thumb 110 moves. Navigation bar 104 may be provided by the application itself, or may be provided by the operating system under which the application operates. In the example of FIG. 1, navigation bar 104 is shown as being oriented vertically, although an alternative (or additional) navigation bar could be oriented horizontally. Clicking and dragging thumb 110 allows the user to change the current position of the document, as does clicking an arbitrary point in track 112. Additionally, in accordance with the subject matter herein, if the user clicks and holds thumb 110, certain things may happen to the way in which the document is being shown to the user which, in effect, implements a “quick glance” mode of viewing. For example, clicking and holding thumb 110 may cause the zoom-level of document 114 to be changed to a full-page zoom level, which is a level at which an entire page of document can been seen within window 102. (Prior to clicking the thumb, the document may have been shown at its native zoom level, or at some zoom level that had been set by the user or chosen in some other way.) In the example of FIG. 1, the use is currently clicking and holding thumb 110, so the zoom level of document 114 that is shown in FIG. 1 is a full-page zoom level. The particular zoom level that is chosen for a full-page level zoom may be one in which at least one of the dimensions of a page (horizontal or vertical) fits snugly against or near the corresponding boundaries of the window, without distorting the aspect ratio of the page. E.g., if boundaries 116 and 118 are the top and bottom boundaries of window 102, it is noted that the first page of document 114 is shown at a zoom level such that the top and bottom edges of that page are close to boundaries 116 and 118. In other words, the document in this example is as shown at, or nearly at, the maximum zoom level that is possible without overflowing the physical size limits of window 102 in either dimension.

While the user is clicking and holding thumb 110, a flyout 120 may be shown. In the example of FIG. 1, flyout 120 is shown next to thumb 110, although flyout 120 could be shown in any appropriate place on the user's screen. Flyout 120 may contain various types of information that may help the user to navigate document 114 while viewing document 114 in glancing mode. In the example of FIG. 1, flyout 120 includes page number 122 (indicating the number of the page of document 114 that is being shown at the full-page zoom level), and thumbnail 124 of that page. However, flyout 120 could contain any appropriate type of information. Additionally, as a way of visually reminding the user that the page he or she is looking at is part of a document, a graphic 126 suggesting a stack of pages behind the current view may be shown.

Thus, FIG. 1 shows window 102 as it would look while the user is clicking and holding the thumb, in order to glance at a document on a per-page basis.

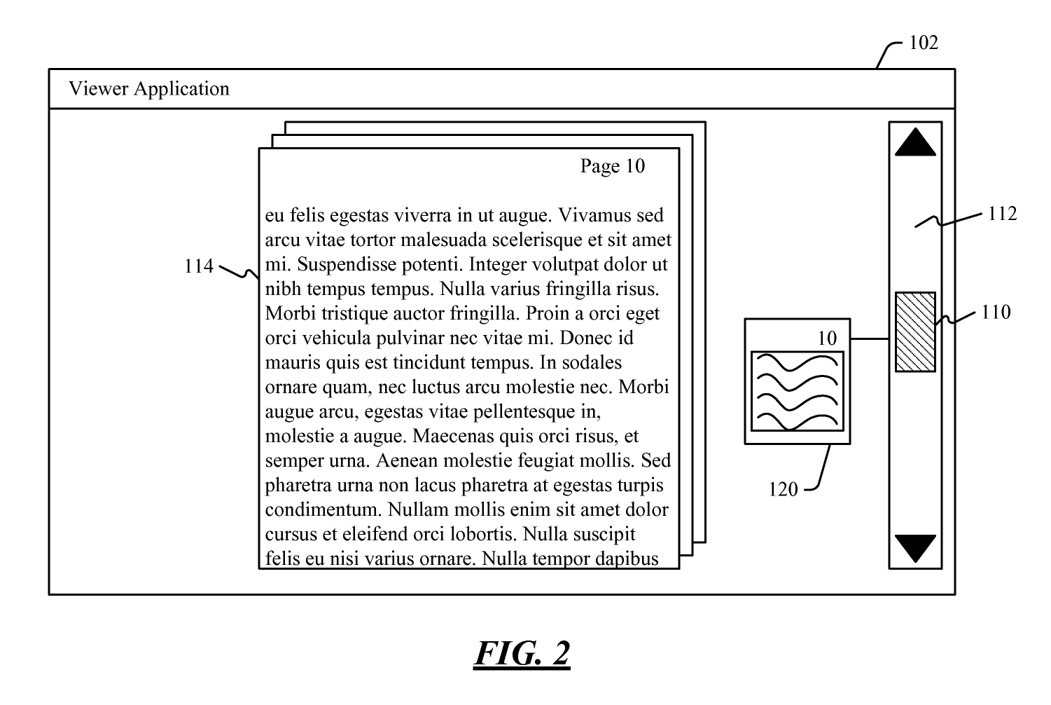

While the user is clicking and holding the thumb, the user may drag the thumb up and down track 112, thereby changing the current page while also remaining in glancing mode. FIG. 2 shows an example of what happens in the window 102 shown in FIG. 1 if the user drags thumb 110 along track 112.

In FIG. 2, the user is continuing to hold thumb 110, thereby causing document 114 to continue to be shown to the user at the full-page zoom level. However, in the example of FIG. 2, the user has dragged thumb 110 from near the top of track 112 to a point in the middle of track 112, thereby repositioning the current view of document 114 from page 1 (as shown in FIG. 1) to page 10. With this move having been made, page 10 is shown in window 102, and—if flyout 120 is being shown—then flyout 120 may be changed to reflect the current page that is being shown, and also by showing a thumbnail of the current page.

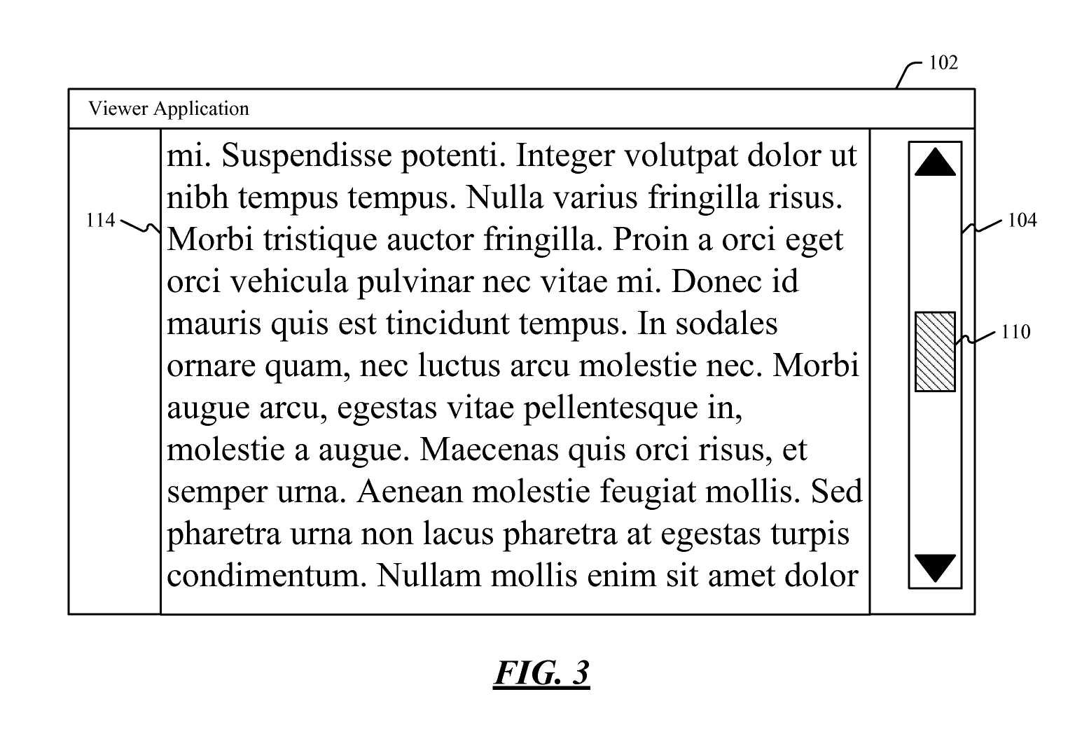

After the user has repositioned the document to a particular place by dragging the thumb, the user may release the thumb, thereby returning the document to the zoom level at which the document had been shown prior to the user's clicking and holding the thumb. FIG. 3 shows what happens when the user releases the thumb after having dragged the thumb to page 10 of the document.

In FIG. 3, window 102 still contains navigation bar 104, including thumb 110. However, in FIG. 3 the user has released thumb 110, thereby causing document 114 to be shown at whatever zoom level was being shown before the user clicked and held thumb 110. For example, document 114 might have been shown at the native zoom level specified by the creator of document 114, or at a zoom level specified by the user, or at a zoom level specified by system default, or at a zoom level chosen in any other way. In the example of FIG. 3, the zoom level that is shown is a higher zoom level (thus, larger print) than the full-page zoom level. Whatever the zoom level was prior to clicking and holding the thumb, releasing the thumb may return to that zoom level. However, if the user dragged the thumb thereby causing the current position of the document to change to another page, then—when the zoom level reverts to the previous zoom level—the page that will be shown is the one that the user has selected by dragging, rather than the page that was shown before the user clicked, held, and dragged the thumb. In this way, the user can easily switch between a glancing view and a detailed-reading view, and can use the glancing view to navigate to the next place in the document where that the user wants to see in detail.

It is noted that FIGS. 1-3 show an example in which the user clicks the thumb and then drags the thumb to reposition the document. However, dragging the thumb is optional. The user could simply click and hold the thumb to switch to a full-page zoom level, and then could release the thumb to switch back to the prior zoom level, without having dragged the thumb to a new position.

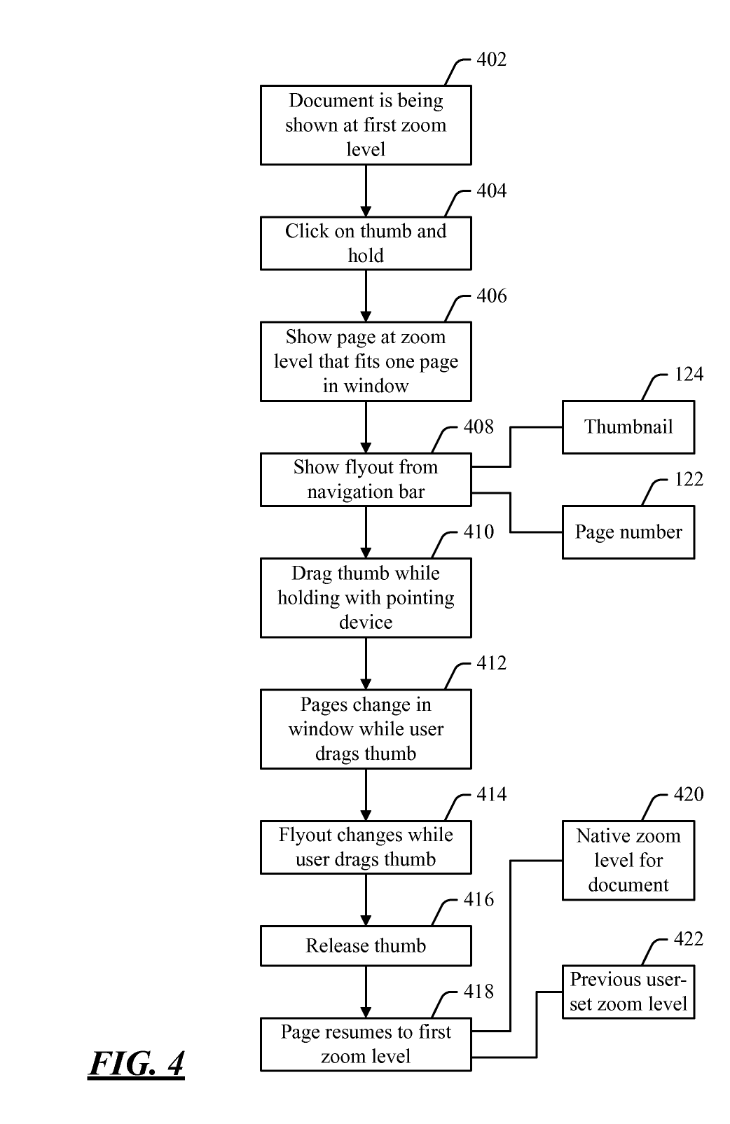

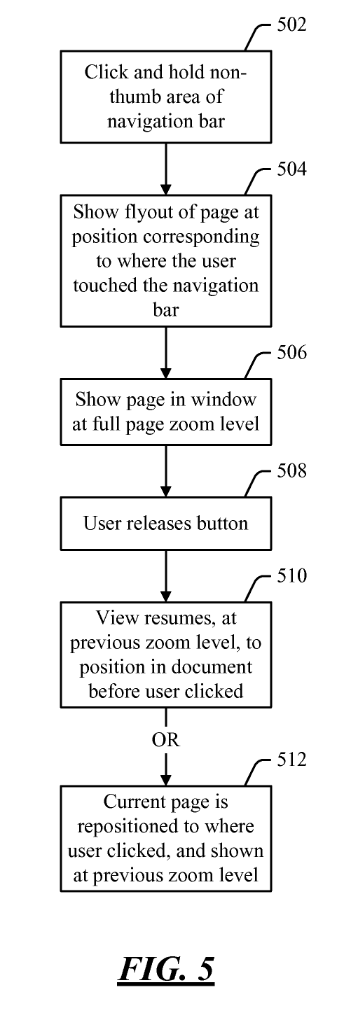

FIG. 4 shows an example process in which a user switched from detailed reading, to glancing, and then back to detailed reading mode. Before turning to a description of FIG. 4, it is noted that the flow diagrams contained herein (both in FIG. 4 and in FIG. 5) are described, by way of example, with reference to components shown in FIGS. 1-3, although these processes may be carried out in any system and are not limited to the scenarios shown in FIGS. 1-3. Additionally, each of the flow diagrams in FIGS. 4 and 5 shows an example in which stages of a process are carried out in a particular order, as indicated by the lines connecting the blocks, but the various stages shown in these diagrams can be performed in any order, or in any combination or sub-combination.

At 402, the document is being shown at a first zoom level. The view in which the document is shown may include a navigation bar, including arrows, a thumb, and a track, as shown in FIGS. 1-3. At 404, the user may click and hold the thumb. The clicking and holding may be done using any type of pointing device—e.g., by depressing and holding the left button on a 2-button wheel mouse, by double-tapping and holding a trackpad, by using a touch screen, or by any other mechanism. A system that receives user input may determine that the user is clicking and holding the thumb as a result of some received indication, such as data sent by the pointing device. As a result of clicking and holding the thumb, the document may be shown at a zoom level that fits one entire page in the window or other viewing area (at 406). One example of such a zoom level is a full-page zoom level that maintains the aspect ratio of the document, while fitting the document closely against the viewing area's boundaries in at least one dimension.

At 408, a flyout from the navigation bar may be shown. It is noted that some implementations of the subject matter herein might not show a flyout, but the subject matter herein includes those implementations that show a flyout as well as those that do not. In one example, the flyout may be shown adjacent to the navigation bar. In a more specific example, the flyout may be shown adjacent to the thumb, and may move alongside the navigation bar as the user drags the thumb from one place to another. The flyout could contain any appropriate type of information. One example piece of information that the flyout could contain is a thumbnail 124 of the current page. Another type of information that the flyout could contain is the page number 122 of the current page.

At 410, the user may drag the thumb while holding the thumb with the pointing device. E.g., on a mouse, the user may hold the left button on the mouse while moving the thumb in the track. When the user drags the thumb, this action repositions the current page to a different point in the document. As the user repositions the document with the thumb, the page shown in the window may change based on the current position (at 412), and the flyout may change as well (at 414). The change of page may appear as an animation—e.g., if the page is changing from page 1 to page 10, then the page shown in the window (as well as the corresponding flyout) may successively show one or more intermediate pages between page 1 and 10, rather than jumping from page 1 to page 10. It is noted that the user might not move the thumb at all, in which case the current position of the document (and the corresponding page view and flyout) would not change.

At 416, the user releases the thumb, either after having dragged the thumb to a new position, or after having not moved the thumb thereby leaving the thumb in its original position. Upon release of the thumb, whatever page is the current page resumes to being shown at the first zoom level (at 418)—i.e., the page may resume to the zoom level at which the document was being viewed at 402 before the user clicked the thumb. This zoom level might be the native zoom level for the document (block 420), or might be the prior level to which the zoom had been set by the user (or by some other entity) before the user clicked the thumb (block 422).

FIG. 5 shows an example process that may occur if the user clicks the navigation bar at a location other than the thumb. At 502, the user clicks and holds a non-thumb (and non-arrow) location in the navigation bar—e.g., anywhere on the track 112 shown in FIG. 1, other than on thumb 110. The location at which the user clicks corresponds to some page in the document. For example, if the document contains 50 pages and the user clicks halfway down the track, the location at which the user clicked may correspond to page 25. (A system that implements the process of FIG. 5 may contain a mechanism to identify the page that corresponds to a particular location on the navigation bar or on the track, in response to the user's having clicked that location on the track.) Thus, at 504, a flyout for to that page may be shown. As in previous examples, the flyout may contain a thumbnail of the page and/or the page number. At 506, the page corresponding to the location at which the user clicked may be shown in the window at a full-page zoom level such that the entire page fits in the viewing area. It is noted that different implementations may exhibit different behaviors when the user clicks on a non-thumb area of the navigation bar—e.g., some implementations may show only a flyout, some implementations may only display the corresponding page in the viewing area, some may show both, or some may show some other information relating to the page.

At 508, the user may release the button that he or she is holding on the pointing device. In response to the user's releasing the button, the flyout may disappear from the screen, and the zoom level may resume to the level to which it was set before the user clicked the button. The page that is shown after the user releases the button may be different in different implementations. In one example implementation, the act of clicking on a non-thumb area of the navigation bar might not reposition the current page, in which case the page that is shown after the user releases the button is whatever page was the current page before the user clicked on a non-thumb area of the navigation bar (at 510). Or, in another example implementation, clicking on a non-thumb area of the navigation bar may reposition the page (either by repositioning to the page at the corresponding location of the navigation bar, or by moving the current page toward that position for as long as the user continues to hold the button on the pointing device), in which case the page that will be viewed after the user releases the button is whatever page is current as a result of the repositioning (at 512).

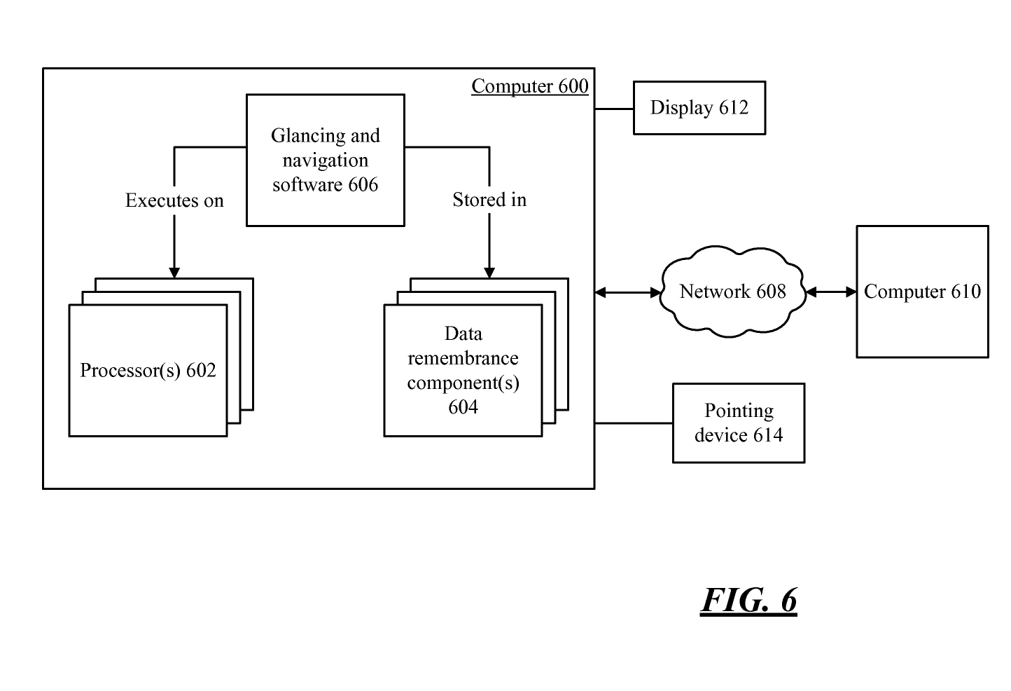

FIG. 6 shows an example environment in which aspects of the subject matter described herein may be deployed.

Computer 600 includes one or more processors 602 and one or more data remembrance components 604. Processor(s) 602 are typically microprocessors, such as those found in a personal desktop or laptop computer, a server, a handheld computer, or another kind of computing device. Data remembrance component(s) 604 are components that are capable of storing data for either the short or long term. Examples of data remembrance component(s) 604 include hard disks, removable disks (including optical and magnetic disks), volatile and non-volatile random-access memory (RAM), read-only memory (ROM), flash memory, magnetic tape, etc. Data remembrance component(s) are examples of computer-readable (or machine-readable) storage media. Computer 600 may comprise, or be associated with, display 612, which may be a cathode ray tube (CRT) monitor, a liquid crystal display (LCD) monitor, or any other type of monitor. Computer 600 may also comprise, or be associated with, a pointing device 614, such as a mouse, track ball, track pad, touch screen, etc. The pointing device may providing the ability to move a cursor or arrow around a screen, and may also have one or more buttons (e.g., left and right buttons on a typical device) which can be separately clicked and to which different meanings are ascribed.

Software may be stored in the data remembrance component(s) 604, and may execute on the one or more processor(s) 602. An example of such software is glancing and navigation software 606, which may implement some or all of the functionality described above in connection with FIGS. 1-5, although any type of software could be used. Software 606 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 6, although the subject matter described herein is not limited to this example.

The subject matter described herein can be implemented as software that is stored in one or more of the data remembrance component(s) 604 and that executes on one or more of the processor(s) 602. As another example, the subject matter can be implemented as instructions that are stored on one or more computer-readable (or machine-readable) storage media. Tangible media, such as an optical disks or magnetic disks, are examples of storage media. The instructions may exist on non-transitory media. Instructions can be stored on computer-readable memories; it will be understood that such memories are physical objects (e.g., semi-conductor memories, disks that exist on tangible platters, tapes), and are not merely wires that carry ephemeral or propagating signals. (However, it will also be understood that those media that are characterized as “storage media” are not mere carriers of ephemeral or propagating signals, but rather are media where data is durably stored.) Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium. It is noted that there is a distinction between media on which signals are “stored” (which may be referred to as “storage media”), and—in contradistinction—media that transmit propagating signals. DVDs, flash memory, magnetic disks, etc., are examples of storage media. On the other hand, wires or fibers on which signals exist ephemerally are examples of transitory signal media.

Additionally, any acts described herein (whether or not shown in a diagram) may be performed by a processor (e.g., one or more of processors 602) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 600 may be communicatively connected to one or more other devices through network 608. Computer 610, which may be similar in structure to computer 600, is an example of a device that can be connected to computer 600, although other types of devices may also be so connected.

It is noted that the claims herein may describe various items as being “distinct.” Two say that two things are distinct is to say that they are not the same instance of a given thing (although the two distinct instances might be identical to each other). For example, two pages may be described as being distinct, which is to say that they are not the same page. E.g., in a 3-page document, page 1 is distinct from page 2 in the sense that they are two separate pages. (Normally these two pages would contain different content, but they would be distinct even if page 1 happened to contain a copy of the same content as page 2.) Similarly, locations may be described as distinct if they are not the same location—e.g., a first location and a second location on a navigation bar are “distinct” if they refer to non-identical spatial locations. Moreover, two zoom levels may be described as distinct if they are not the same zoom level—e.g., 100% is a distinct zoom level from 200%. Additionally, it is noted that in some cases the subject matter herein refers to items by the labels “first”, “second”, “third”, etc. It will be understood that, in a claim that defines a “first page” and a “second page”, the claim would cover situations where the first page and the second page are the same page, and would also cover situations where they are distinct pages, unless the claim specifies otherwise (e.g., by referring to the first page and the second page as being “distinct”, or as being “the same”). In some cases, an independent claim might cover both situations by virtue of its silence as to whether the pages are “distinct” or “the same”, but a dependent claim might limit the first and second pages to being “distinct”, in which case the pages would be limited to being distinct for the purpose of the dependent claim, but not for the independent claim.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable memories that store executable instructions to display a document, wherein the executable instructions, when executed by a computer, cause the computer to perform acts comprising:
displaying a first page of a document at a first zoom level with a navigation bar that has a track and a thumb in said track;
receiving a first indication that a user is clicking and holding said thumb with a pointing device;
based on said user's clicking and holding said thumb, displaying said first page at a second zoom level that is distinct from said first zoom level and that allows said first page to fit entirely within a viewing area;
receiving a second indication that said user has released said thumb with said pointing device; and
based on said user's having released said thumb, displaying a current page of said document at said first zoom level.

2. The one or more computer-readable memories of claim 1, wherein said acts further comprise:
based on said user's clicking and holding said thumb, displaying a flyout that represents said first page.

3. The one or more computer-readable memories of claim 2, wherein said flyout comprises a page number of said first page.

4. The one or more computer-readable memories of claim 2, wherein said flyout comprises a thumbnail of said first page.

5. The one or more computer-readable memories of claim 2, wherein said acts further comprise:
receiving a third indication that said user has moved said thumb with said pointing device while continuing to hold said thumb with said pointing device; and
while said thumb moves, changing said flyout to represents pages that correspond to a position of said thumb in said track.

6. The one or more computer-readable memories of claim 1, wherein said acts further comprise:
receiving a third indication that said user has moved said thumb with said pointing device while continuing to hold said thumb with said pointing device; and
while said thumb moves, changing which page appears in said viewing area.

7. The one or more computer-readable memories of claim 1, wherein said acts further comprise:
receiving a third indication that said user has moved said thumb with said pointing device from a first location in said track to a second location in said track; and
based on moving of said thumb, changing said current page from said first page to a second page that is distinct from said first page, so that said second page is shown at said first zoom level when said user releases said thumb.

8. A method of displaying a document, the method comprising:
using a processor to perform acts comprising:
displaying a first page of a document at a first zoom level in a viewing area;
first determining that a user is holding a thumb of a navigation bar that is displayed with said document;
based on said first determining, displaying, in said viewing area, said first page at a second zoom level that is distinct from said first zoom level;
second determining that said user has moved said thumb from a first location in a track of said navigation bar to a second location in said track that is distinct from said first location;
third determining that said user has released said thumb; and
based on said third determining, displaying, in said viewing area and at said first zoom level, a second page that corresponds to said second location in said track.

9. The method of claim 8, wherein said acts further comprise:
based on said first determining, displaying a flyout that represents said first page.

10. The method of claim 9, wherein said flyout comprises a page number of said first page.

11. The method of claim 9, wherein said flyout comprises a thumbnail of said first page.

12. The method of claim 9, wherein said acts further comprise:
while said user is moving said thumb, changing said flyout to represent pages that correspond to locations of said thumb in said track.

13. The method of claim 8, wherein said acts further comprise:
while said user is moving said thumb, changing a page that appears in said viewing area to correspond to which page appears in said viewing area.

14. The method of claim 8, further comprising:
while said first page is being displayed at said second zoom level, showing a graphic indicating a stack of pages behind said first page.

15. A device that displays a document, the device comprising:
a display;
a memory;
a processor; and
a component that is stored in said memory and that executes on said processor, that displays a first page of a document in a viewing area on said display at a first zoom level, that also displays, on said display, a navigation bar that comprises a track and a thumb in said track, that receives input from a user indicating that said user is clicking and holding a point on said track, that, in response to said user's clicking and holding said point on said track, displays a second page of said document at a second zoom level that is distinct from said first zoom level, that determines that said user has released said navigation bar, and that, in response to said user's releasing of said navigation bar, displays a third page of said document in said viewing area at said first zoom level, said second zoom level allowing said first page or said second page to fit entirely within said viewing area.

16. The device of claim 15, wherein said component determines that said user is clicking and holding a non-thumb area of said navigation bar and, in response to said user's clicking and holding of said non-thumb area, identifies said second page to be a page whose position in said document corresponds to said point, said second page being distinct from said first page.

17. The device of claim 15, wherein said component determines that said user is clicking and holding a non-thumb area of said navigation bar and, in response to said user's clicking and holding of said non-thumb area, shows a flyout of said second page, said second page being selected to be a page in said document whose position corresponds to said point, said second page being distinct from said first page.

18. The device of claim 15, wherein said component determines that said user is clicking and holding a non-thumb area of said navigation bar and, in response to said user's clicking and holding of said non-thumb area, changes a current page of said document to said second page, said second page being selected to be a page whose location in said document corresponds to said point, said second page being distinct from said first page, said third page being the same page as said second page.

19. The device of claim 15, wherein said component determines that said user is clicking and holding a non-thumb area of said navigation bar and, in response to said user's clicking and holding of said non-thumb area, identifies said second page to be a page whose position in said document corresponds to said point and, when said user releases said navigation bar, resumes displaying a place in said document at which said user was viewing prior to clicking and holding, said second page being distinct from said first page and from said third page, said first page being the same page as said third page.

20. The device of claim 15, wherein said component determines that said user is clicking and holding said thumb, said second page being the same page as said first page.
